(19) United States
(12) Patent Application Publication
(10) Pub. No.: US 2026/0009739 A1
(43) Pub. Date: Jan. 8, 2026

(54) POLARIZATION CONTROL AND OPTIMIZATION FOR PHOTOMASK DEFECT DETECTION

(71) Applicant: KLA Corporation, Milpitas, CA (US)

(72) Inventors: Yun Xie, Pudong (CN); Haifeng Huang, Livermore, CA (US); Xin Ye, Shanghai (CN); Heng Zhang, Shanghai (CN); Rui-Fang Shi, Cupertino, CA (US)

(21) Appl. No.: 19/250,973

(22) Filed: Jun. 26, 2025

Related U.S. Application Data
(60) Provisional application No. 63/666,670, filed on Jul. 2, 2024.

(51) Int. Cl. G01N 21/956; G01N 21/21

(52) U.S. Cl. CPC G01N 21/956; G01N 21/21; G01N 2021/95676

(57) ABSTRACT

A recipe generation system may include a controller with one or more processors configured to execute program instructions. The instructions may cause the processors to generate a performance matrix for one or more defect types. The performance matrix may include inspection data generated with multiple polarization states of illumination light associated with rotational positions of at least two waveplates in a polarization controlling optics of an inspection system. The polarization controlling optics may include a polarizing beam splitter and the waveplates. The system may generate inspection data by propagating illumination light through the optics to the sample and capturing light from the sample by a detector through the optics. The processors may identify a run-time polarization state satisfying an inspection tolerance and generate an inspection recipe using the run-time polarization states.

### CROSS-REFERENCE TO RELATED APPLICATIONS

The present application claims the benefit under 35 U.S.C. § 119(e) of U.S. Provisional Application Ser. No. 63/666,670, filed Jul. 2, 2024, naming Yun Xie, Haifeng Huang, Xin Ye, Heng Zhang, and Rui-Fang Shi as inventors, which is incorporated herein by reference in the entirety.

### TECHNICAL FIELD

The present disclosure relates to photomask inspection systems, and more particularly to polarization control and optimization techniques for photomask inspection systems.

### BACKGROUND

Photomask inspection systems play a crucial role in semiconductor manufacturing processes, enabling the detection of defects on photomasks. As feature sizes continue to shrink and pattern complexity increases, particularly for advanced technologies like extreme ultraviolet (EUV) photomasks, inspection systems face growing challenges in achieving adequate sensitivity and accuracy. There is therefore a need to develop systems and methods providing increased performance in photomask inspection.

### SUMMARY

In some embodiments, a recipe generation system is provided. The recipe generation system may include a controller including one or more processors configured to execute program instructions. The program instructions may cause the one or more processors to generate a performance matrix for each of one or more defect types. The performance matrix may include inspection data generated with a plurality of polarization states of illumination light associated with rotational positions of at least two waveplates in a polarization controlling optics of an inspection system. The polarization controlling optics may include a polarizing beam splitter and the at least two waveplates positioned between the polarizing beam splitter and a sample. The inspection system may generate the inspection data by propagating the illumination light through the polarization controlling optics to the sample and capturing light from the sample by a detector through the polarization controlling optics. The program instructions may cause the one or more processors to identify a run-time polarization state from the plurality of polarization states. The run-time polarization state may satisfy an inspection tolerance for the one or more defect types. The program instructions may cause the one or more processors to generate an inspection recipe to inspect one or more samples with the illumination light having the run-time polarization state.

In some embodiments, the inspection recipe may define the rotational positions of the at least two waveplates of the polarization controlling optics.

In some embodiments, the at least two waveplates of the polarization controlling optics may include a first set of waveplates. The first set of waveplates may be swappable with at least a second set of waveplates. The second set of waveplates may include one or more second waveplates. The program instructions may further cause the one or more processors to identify rotational positions of the one or more second waveplates providing the run-time polarization state. The inspection recipe may define the rotational positions of the one or more second waveplates providing the run-time polarization state.

In some embodiments, the one or more second waveplates may include a single second waveplate.

In some embodiments, the one or more second waveplates may include one or more quarter waveplates.

In some embodiments, the one or more defect types may include two or more defect types.

In some embodiments, identifying the run-time polarization state from the plurality of polarization states may include identifying the run-time polarization state from the plurality of polarization states based on a dimensionality reduction operation.

In some embodiments, the dimensionality reduction operation may include principal component analysis.

In some embodiments, identifying the run-time polarization state from the plurality of polarization states may include identifying a first run-time polarization state from the plurality of polarization states. The first run-time polarization state may satisfy the inspection tolerance for a first set of the two or more defect types. Identifying the run-time polarization state may include identifying a second run-time polarization state from the plurality of polarization states. The second run-time polarization state may satisfy the inspection tolerance for a second set of the two or more defect types.

In some embodiments, generating the performance matrix for each of the one or more defect types and identifying the run-time polarization state from the plurality of polarization states may be performed iteratively with increasingly smaller step sizes of variations of the rotational positions of the at least two waveplates.

In some embodiments, the inspection tolerance may be based on a metric incorporating at least one of signal to noise ratio, through-focus peak signal, or pattern feature edge ringing.

In some embodiments, an inspection system is provided. The inspection system may include an inspection sub-system. The inspection sub-system may include an illumination source configured to generate illumination light. The inspection sub-system may include a polarization controlling optics positioned in an optical path between the illumination source and a sample. The polarization controlling optics may include a polarizing beam splitter and at least two waveplates positioned between the polarizing beam splitter and the sample. The at least two waveplates may be separately rotatable. The inspection sub-system may include a detector configured to collect light from the sample through the polarization controlling optics. The inspection system may include a controller including one or more processors configured to execute program instructions. The program instructions may cause the one or more processors to generate a performance matrix for each of one or more defect types. The performance matrix may include inspection data generated with a plurality of polarization states of the illumination light associated with rotational positions of the at least two waveplates in the polarization controlling optics. The program instructions may cause the one or more processors to identify a run-time polarization state from the plurality of polarization states. The run-time polarization state may satisfy an inspection tolerance for the one or more defect types. The program instructions may cause the one or more processors to generate an inspection recipe to inspect one or more samples with the illumination light having the run-time polarization state. The inspection sub-system may be configured to inspect the one or more samples based on the inspection recipe. The program instructions may cause the one or more processors to generate run-time inspection measurements for the one or more samples based on data from the inspection sub-system.

In some embodiments, the inspection recipe may define the rotational positions of the at least two waveplates of the polarization controlling optics.

In some embodiments, the at least two waveplates of the polarization controlling optics may include a first set of waveplates. The first set of waveplates may be swappable with at least a second set of waveplates. The second set of waveplates may include one or more second waveplates. The program instructions may further cause the one or more processors to identify rotational positions of the one or more second waveplates providing the run-time polarization state. The inspection recipe may define the rotational positions of the one or more second waveplates providing the run-time polarization state.

In some embodiments, the one or more defect types may include two or more defect types.

In some embodiments, identifying the run-time polarization state from the plurality of polarization states may include identifying the run-time polarization state from the plurality of polarization states based on a dimensionality reduction operation.

In some embodiments, identifying the run-time polarization state from the plurality of polarization states may include identifying a first run-time polarization state from the plurality of polarization states. The first run-time polarization state may satisfy the inspection tolerance for a first set of the two or more defect types. Identifying the run-time polarization state may include identifying a second run-time polarization state from the plurality of polarization states. The second run-time polarization state may satisfy the inspection tolerance for a second set of the two or more defect types.

In some embodiments, generating the performance matrix for each of the one or more defect types and identifying the run-time polarization state from the plurality of polarization states may be performed iteratively with increasingly smaller step sizes of variations of the rotational positions of the at least two waveplates.

In some embodiments, the sample may include a photomask.

In some embodiments, the illumination light may include deep ultraviolet light.

In some embodiments, an inspection method is provided. The method may include generating a performance matrix for each of one or more defect types. The performance matrix may include inspection data generated with a plurality of polarization states of illumination light associated with rotational positions of at least two waveplates in a polarization controlling optics of an inspection system. The polarization controlling optics may include a polarizing beam splitter and the at least two waveplates positioned between the polarizing beam splitter and a sample. The inspection system may generate the inspection data by propagating the illumination light through the polarization controlling optics to the sample and capturing light from the sample by a detector through the polarization controlling optics. The method may include identifying a run-time polarization state from the plurality of polarization states. The run-time polarization state may satisfy an inspection tolerance for the one or more defect types. The method may include generating an inspection recipe to inspect one or more samples with the illumination light having the run-time polarization state. The method may include generating run-time data for the one or more samples based on the inspection recipe with the inspection system.

In some embodiments, generating the inspection recipe to inspect the one or more samples with the illumination light having the run-time polarization state may include generating the inspection recipe to include the rotational positions of the at least two waveplates of the polarization controlling optics.

In some embodiments, the at least two waveplates of the polarization controlling optics may include a first set of waveplates. The first set of waveplates may be swappable with at least a second set of waveplates. The second set of waveplates may include one or more second waveplates. Generating the inspection recipe to inspect the one or more samples with the illumination light having the run-time polarization state may include identifying rotational positions of the one or more second waveplates providing the run-time polarization state.

In some embodiments, identifying the run-time polarization state from the plurality of polarization states may include identifying the run-time polarization state from the plurality of polarization states based on a dimensionality reduction operation.

In some embodiments, the one or more defect types may include two or more defect types. Identifying the run-time polarization state from the plurality of polarization states may include identifying a first run-time polarization state from the plurality of polarization states. The first run-time polarization state may satisfy the inspection tolerance for a first set of the two or more defect types. Identifying the run-time polarization state may include identifying a second run-time polarization state from the plurality of polarization states. The second run-time polarization state may satisfy the inspection tolerance for a second set of the two or more defect types.

In some embodiments, generating the performance matrix for each of the one or more defect types and identifying the run-time polarization state from the plurality of polarization states may be performed iteratively with increasingly smaller step sizes of variations of the rotational positions of the at least two waveplates.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF FIGURES

The numerous advantages of the disclosure may be better understood by those skilled in the art by reference to the accompanying figures.

FIG. 1A illustrates a block diagram of an inspection system, in accordance with one or more embodiments of the present disclosure.

FIG. 1B illustrates a block diagram of an inspection sub-system, in accordance with one or more embodiments of the present disclosure.

FIG. 1C illustrates a block diagram of an inspection system with polarization controlling optics, in accordance with one or more embodiments of the present disclosure.

FIG. 1D illustrates a block diagram of an inspection system with multiple polarization control configurations, in accordance with one or more embodiments of the present disclosure.

FIG. 2A illustrates a flowchart of a method for optimizing polarization settings in an inspection system, in accordance with one or more embodiments of the present disclosure.

FIG. 2B illustrates a flowchart detailing a portion of a method for implementing polarization settings in an inspection system, in accordance with one or more embodiments of the present disclosure.

FIG. 2C illustrates a flowchart of a method for determining and implementing polarization states in an inspection system, in accordance with one or more embodiments of the present disclosure.

FIG. 2D illustrates a flowchart of a method for optimizing polarization settings in an inspection system, in accordance with one or more embodiments of the present disclosure.

FIG. 3 depicts a matrix of polarization states that may be achieved using different rotations of waveplates, in accordance with one or more embodiments of the present disclosure.

FIG. 4 illustrates a flowchart of a method for optimizing polarization settings in an inspection system, in accordance with one or more embodiments of the present disclosure.

FIG. 5 depicts a composite diagram showing defect analysis and polarization optimization results, in accordance with one or more embodiments of the present disclosure.

FIG. 6 depicts edge profile plots for isolated horizontal and vertical lines, in accordance with one or more embodiments of the present disclosure.

FIG. 7 depicts a comparison of defect detection performance using different polarization configurations, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing enhanced defect detection through polarization control and optimization analysis. It is contemplated herein that the sensitivity of an optical defect inspection system may vary based on the polarization of illumination light and a particular layout of features on a sample being inspected. As a result, it may be desirable to select a polarization state designed to provide high inspection sensitivity for a given set of defects of interest.

In embodiments, a polarization control system may include polarization control optics with multiple waveplates and a polarizing beam splitter (PBS) to generate arbitrary polarization states of illumination light. For example, the generation of arbitrary polarization states using multiple waveplates is generally described in U.S. Pat. No. 10,168,273, which is incorporated herein by reference in its entirety. The systems and methods disclosed herein may utilize any technique for polarization control including, but not limited to, techniques disclosed in U.S. Pat. No. 10,168,273. For example, different polarization states may be generated using different rotations (e.g., rotational positions) of the waveplates.

Some embodiments of the present disclosure are directed to selecting a polarization state providing high sensitivity for a particular set of defect types of interest. In some embodiments, a performance matrix is generated for a selected set of defect types, where the performance matrix includes inspection data generated with different polarization states (e.g., different rotations of waveplates in the polarization controlling optics.

In some embodiments, a dimensionality reduction technique such as, but not limited to, principal component analysis (PCA) may be implemented to select polarization states suitable for detecting multiple defect types. A dimensionality reduction technique may provide a basis for identifying polarization states that offer enhanced performance across multiple defect types simultaneously. For example, a PCA analysis may identify principal components that capture the most significant variations in defect detection performance, which may then enable determining which polarization states contribute most effectively to overall inspection capability. More broadly, the use of dimensionality reduction techniques as disclosed herein may enable the selection of a single optimized polarization state that satisfies inspection tolerances for multiple defect types, or alternatively, may identify a reduced set of polarization states that collectively provide comprehensive coverage for all defect types of interest.

The systems and methods disclosed herein may be applied to any type of defect inspection application. In some cases, the systems and methods described herein may be applied to inspect EUV photomasks using deep ultraviolet (DUV) light. The ability to optimize polarization states for specific pattern regions and defect types may help overcome challenges associated with inspecting sub-wavelength EUV mask features.

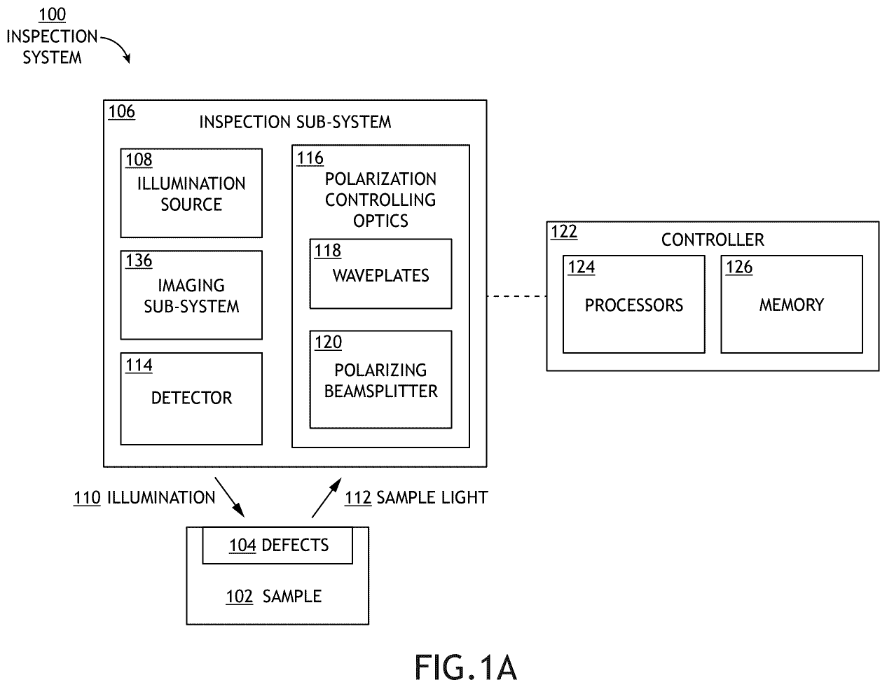

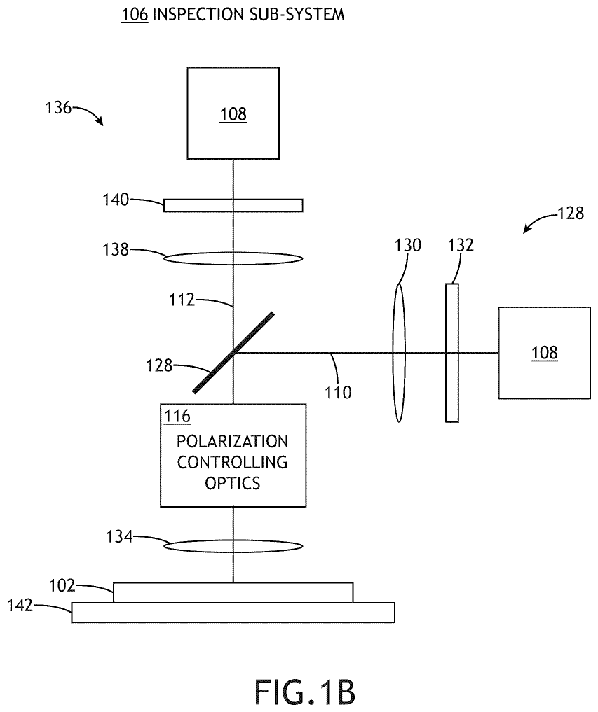

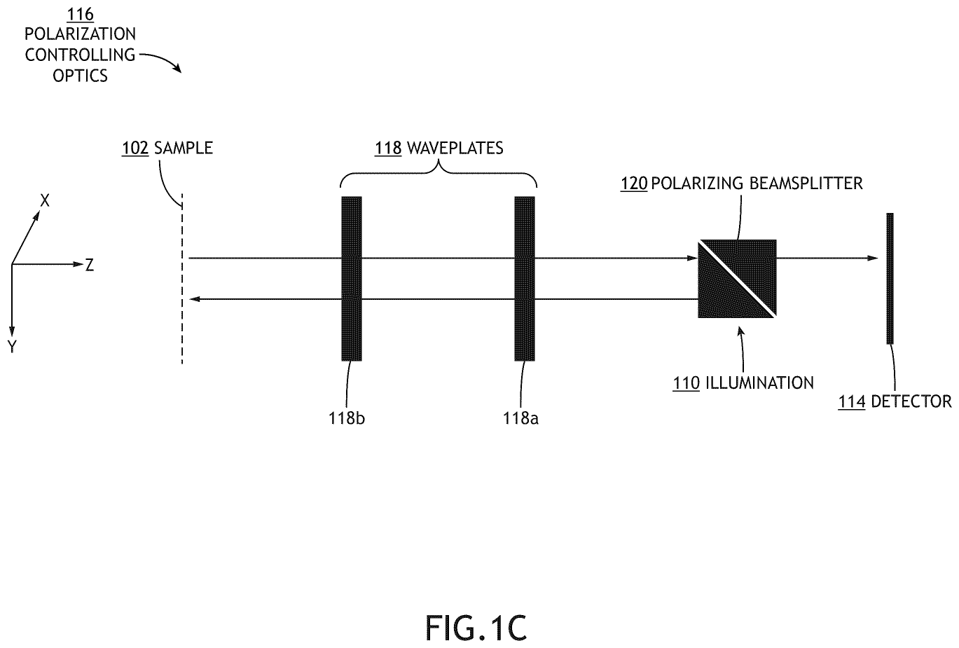

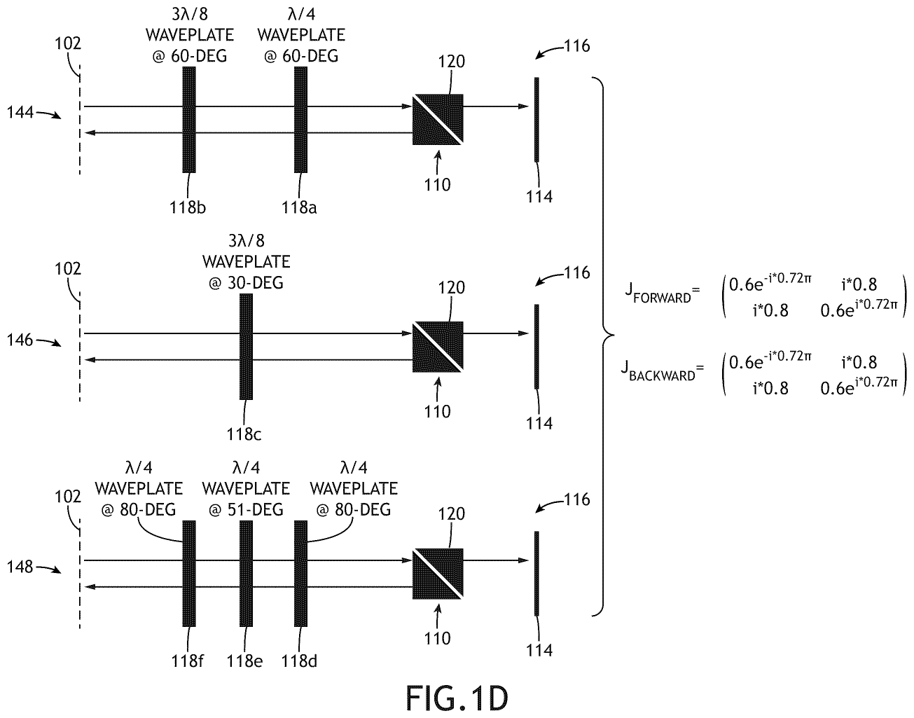

Referring now to FIGS. 1A-7, systems and methods providing polarization-selective inspection are described in greater detail, in accordance with one or more embodiments of the present disclosure.

FIG. 1A illustrates a block diagram of an inspection system 100, in accordance with one or more embodiments of the present disclosure. The inspection system 100 includes an inspection sub-system 106 configured to inspect a sample 102 having defects 104.

In embodiments, the inspection sub-system 106 includes an illumination source 108 that generates illumination 110, directs this illumination to a sample 102, captures light from the sample 102 (e.g., sample light 112), and detects at least a portion of this sample light 112 with a detector 114. For example, the inspection sub-system 106 may include an imaging sub-system (e.g., imaging optics) to image at least a portion of the sample 102 onto the detector 114 based on collected sample light 112.

In embodiments, the inspection sub-system 106 includes polarization controlling optics 116 to control a polarization state of the illumination 110 incident on the sample 102 and, in some cases, further manipulate the polarization of the sample light 112 that may reach the detector 114. The polarization controlling optics 116 may include any components suitable for manipulating the polarization of light including, but not limited to, one or more waveplates 118 and one or more polarizing beamsplitters 120.

The inspection system 100 may be suitable for inspecting any type of sample 102. For example, the sample 102 includes a photomask used during a lithographic exposure step of a semiconductor fabrication process. As an illustration, the sample 102 may include an extreme ultraviolet (EUV) photomask.

In embodiments, the inspection system 100 may implement an inspection recipe that defines various operational parameters and configurations for performing defect inspection. For example, the inspection recipe may specify aspects of the illumination 110 such as, but not limited to polarization, spectral properties, incidence angle, intensity, or beam shape. As another example, the inspection recipe may specify aspects of the polarization controlling optics 116 suitable for providing illumination 110 with desired properties. As another example, the inspection recipe may specify aspects of the sample light 112 to be passed to a detector 114. As another example, the inspection recipe may also include information about the design of the sample 102, such as pattern layouts, feature dimensions, or critical areas that require enhanced inspection sensitivity. The inspection recipe may further specify inspection parameters such as, but not limited to, illumination wavelength, detector settings, scan patterns, or focus positions.

In embodiments, the inspection system 100 also includes a controller 122, which may be communicatively coupled with any component of the inspection system 100 including, but not limited to, the inspection sub-system 106. The controller 122 may include processors 124 and memory 126. For example, the processors 124 may execute instructions stored in the memory 126 to perform various steps disclosed herein. In some cases, the controller 122 may directly or indirectly (e.g., via control signals) perform any steps described in the present disclosure.

The one or more processors 124 of the controller 122 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 124 may include any device configured to execute algorithms and/or instructions (e.g., program instructions stored in memory). In some cases, the one or more processors 124 may be embodied as a desktop computer, mainframe computer system, workstation, image computer, parallel processor, networked computer, or any other computer system configured to execute a program configured to operate or operate in conjunction with the system, as described throughout the present disclosure.

The memory 126 may include any storage medium known in the art suitable for storing program instructions executable by the associated one or more processors 124. For example, the memory 126 may include a non-transitory memory medium. By way of another example, the memory 126 may include, but is not limited to, a read-only memory (ROM), a random-access memory (RAM), a magnetic or optical memory device (e.g., disk), a magnetic tape, a solid-state drive and the like. In some cases, the memory 126 may be housed in a common controller housing with the one or more processors 124. In some cases, the memory 126 may be located remotely with respect to the physical location of the one or more processors 124 and controller 122. For instance, the one or more processors 124 of the controller 122 may access a remote memory (e.g., server), accessible through a network (e.g., internet, intranet and the like).

Referring now to FIG. 1B, the inspection sub-system 106 is described in greater detail.

The illumination source 108 may include any type of illumination source known in the art suitable for generating an optical illumination 110, which may be in the form of one or more illumination beams. Further, the illumination 110 may have any spectrum such as, but not limited to, ultraviolet (UV) wavelengths, visible wavelengths, or infrared (IR) wavelengths. Further, the illumination source 108 may be a broadband source, a narrowband source, and/or a tunable source.

In some embodiments, the illumination source 108 includes a broadband plasma (BBP) illumination source. In this regard, the illumination 110 may include radiation emitted by a plasma. For example, a BBP illumination source 108 may include, but is not required to include, one or more pump sources (e.g., one or more lasers) configured to focus into the volume of a gas, causing energy to be absorbed by the gas in order to generate or sustain a plasma suitable for emitting radiation. Further, at least a portion of the plasma radiation may be utilized as the illumination 110.

In some embodiments, the illumination source 108 may include any laser system known in the art capable of emitting radiation in the infrared, visible, or ultraviolet portions of the electromagnetic spectrum.

The illumination source 108 may further produce illumination 110 having any temporal profile. For example, the illumination source 108 may produce continuous-wave (CW) illumination 110, pulsed illumination 110, or modulated illumination 110. Additionally, the illumination 110 may be delivered from the illumination source 108 via free-space propagation or guided light (e.g., an optical fiber, a light pipe, or the like).

The illumination sub-system 128 may include various components to direct the illumination 110 to the sample 102 such as, but not limited to, illumination lenses 130, mirrors, or the like. Further, such components may be reflective elements or transmissive elements. In this way, the depiction of the illumination lenses 130 in FIG. 1B as transmissive elements is merely illustrative and not limiting. The illumination sub-system 128 may further include one or more illumination control optics 132 to modify and/or condition light in the associated optical path such as, but not limited to, one or more polarizers, one or more filters, one or more beam splitters, one or more diffusers, one or more homogenizers, one or more apodizers, or one or more beam shapers.

In some embodiments, the inspection system 100 includes a stage 142 for securing and/or positioning the sample 102 during imaging. For example, the stage 142 may include any combination of linear actuators, rotational actuators, or angle actuators to position the sample 102 using any number of degrees of freedom.

The imaging sub-system 136 may include various components to collect at least a portion of the sample light 112 emanating from the sample 102 and direct at least a portion of the sample light 112 to a detector 114. In some cases, the inspection sub-system 106 generates one or more images of the sample 102. An image generated by the inspection system 100 may be any type of image known in the art such as, but not limited to, a brightfield image, a darkfield image, a phase-contrast image, or the like.

The imaging sub-system 136 may include various components to direct the sample light 112 to the detector 114 such as, but not limited to, collection lenses 138, mirrors, or the like. The imaging sub-system 136 may further include one or more collection control optics 140 to modify and/or condition light in the associated optical path such as, but not limited to, one or more polarizers, one or more filters, one or more beam splitters, one or more diffusers, one or more homogenizers, one or more apodizers, or one or more beam shapers.

The various components of the inspection sub-system 106 may be formed as reflective elements or transmissive elements. In this way, the depiction of transmissive optical elements in FIG. 1B is merely illustrative and not limiting.

The detector 114 may include any type of sensor known in the art suitable for measuring sample light. For example, a detector 114 may include a multi-pixel sensor such as, but not limited to, a charge-couple device (CCD), a complementary metal-oxide-semiconductor (CMOS) device, a line sensor, or a time-delay-integration (TDI) sensor. As another example, a detector 114 may include two or more single-pixel sensors such as, but not limited to, a photodiode, an avalanche photodiode, a photomultiplier tube, or a single-photon detector.

The illumination sub-system 128 and the imaging sub-system 136 may be configured in various ways within the spirit and scope of the present disclosure. In some embodiments, as illustrated in FIG. 1B, the inspection system 100 includes at least one beamsplitter (e.g., polarizing beamsplitter 120) common to the optical paths of the illumination sub-system 128 and the imaging sub-system 136. In this way, the illumination sub-system 128 and the imaging sub-system 136 may both share a common objective lens 134 and may both utilize the full available pupil or numerical aperture (NA) provided by the objective lens 134. In some embodiments, though not shown, the illumination sub-system 128 and the imaging sub-system 136 may have separate optical paths without common elements.

Further, as shown in FIG. 1B, the polarization controlling optics 116 may operate on both the illumination 110 and the sample light 112 collected from the sample 102. In this way, the polarization controlling optics 116 may be characterized as a separate component or as part of both the illumination sub-system 128 and/or the imaging sub-system 136.

FIG. 1C illustrates a block diagram of a portion of the inspection system 100 including the polarization controlling optics 116, in accordance with one or more embodiments of the present disclosure.

As described previously herein, the polarization controlling optics 116 may include one or more waveplates 118 and a polarizing beamsplitter 120. For example, FIG. 1C depicts a configuration with a first waveplate 118a and a second waveplate 118b positioned between the polarizing beamsplitter 120 and the sample 102.

In some embodiments, the waveplates 118 are positioned between the polarizing beamsplitter 120 and the sample 102 such that the waveplates 118 may manipulate the polarization of illumination 110 incident on the sample 102. Further, as shown in FIG. 1C, the sample light 112 may also propagate back through the waveplates 118 such that the waveplates 118 may further manipulate the polarization of the sample light 112. As an illustration, the polarizing beamsplitter 120 may direct linearly-polarized light to the waveplates 118, where the waveplates 118 may modify the polarization of the illumination 110 to a selected polarization state. The polarization state of sample light 112 may then be modified by the waveplates 118 and analyzed by the polarizing beamsplitter 120 prior to reaching the detector 114.

The polarization controlling optics 116 may include any number of waveplates 118 of any thicknesses. Further, the waveplates 118 may be independently adjustable to provide illumination 110 with any arbitrary polarization state.

The polarization control of the illumination 110 may be described using Jones matrix formalism to characterize the transformation of polarization states through the waveplates 118a/118b. In some embodiments, the Jones matrix of a waveplate 118 may be expressed as:

$${J}_{WP} ( φ , θ ) = ( \begin{matrix}cos \frac{φ}{2} + i sin \frac{φ}{2} cos 2 θ & i sin \frac{φ}{2} sin 2 θ \\ i sin \frac{φ}{2} sin 2 θ & cos \frac{φ}{2} - i sin \frac{φ}{2} cos 2 θ\end{matrix} ) \qquad ( 1 )$$

where φ represents a phase retardance of the waveplate 118 and θ represents the orientation angle of the slow axis of the waveplate with respect to a reference axis, and i is the imaginary unit.

The polarization transformation through the system can be described using Jones calculus, which mathematically represents how the waveplates 118 modify the polarization state of light traveling from the polarizing beamsplitter 120 to the sample 102 and back. By adjusting the rotational positions of the waveplates 118, various polarization states can be generated, including linear polarization of arbitrary orientation, elliptical polarization of various eccentricities, and circular polarization.

For example, the Jones matrix of a cascade of N waveplates 118 from the polarizing beamsplitter 120 to the sample 102 may be derived using Jones calculus as:

$${J}_{forward} = {J}_{N} ( {φ}_{N} , {θ}_{N} ) \cdot {J}_{N - 1} ( {φ}_{N - 1} , {θ}_{N - 1} ) \cdot … \cdot {J}_{2} ( {φ}_{2} , {θ}_{2} ) \cdot {J}_{1} ( {φ}_{1} , {θ}_{1} ) \qquad ( 2 )$$

where Jᵢ(φᵢ,θᵢ) represents the Jones matrix of the i-th waveplate with phase retardance φᵢ and orientation angle θᵢ. Using this formalism, the Jones matrix from the sample 102 back to the polarizing beamsplitter 120 may generally be represented by:

$${J}_{backward} = {J}_{1} ( {φ}_{1} , - {θ}_{1} ) \cdot {J}_{2} ( {φ}_{2} , - {θ}_{2} ) \cdot … \cdot {J}_{N - 1} ( {φ}_{N - 1} , - {θ}_{N - 1} ) \cdot {J}_{N} ( {φ}_{N} , - {θ}_{N} ) \cdot ( \begin{matrix}1 & 0 \\ 0 & - 1\end{matrix} ) \qquad ( 3 )$$

The electric field of illumination light after the waveplates and polarizing beamsplitter 120 polarization control system may be described using:

$${E}_{out} = {J}_{PBS} \cdot {J}_{backward} \cdot {J}_{mask} \cdot {J}_{forward} \cdot {J}_{PBS} \cdot {E}_{in} \qquad ( 4 )$$

where J_{PBS} represents the Jones matrix of the polarizing beamsplitter 120, Jₘₐₛₖ represents the interaction with the sample 102, and Eᵢₙ and Eₒᵤₜ represent the input and output electric fields, respectively.

The Jones matrix of an individual waveplate may exhibit the following symmetry property:

$$( \begin{matrix}1 & 0 \\ 0 & - 1\end{matrix} ) \cdot {J}_{i} ( {φ}_{i} , - {θ}_{i} ) = {J}_{i} ( {φ}_{i} , {θ}_{i} ) \cdot ( \begin{matrix}1 & 0 \\ 0 & - 1\end{matrix} ) \qquad ( 5 )$$

where

$${J}_{i} ( {φ}_{i} , {θ}_{i} ) = {J}_{i}^{T} ( {φ}_{i} , {θ}_{i} ) ,$$

indicating the transpose relationship for the waveplate Jones matrix. Accordingly,

$${J}_{backward} = ( \begin{matrix}1 & 0 \\ 0 & - 1\end{matrix} ) \cdot {J}_{forward}^{T} \qquad ( 6 )$$

In some embodiments, the polarization controlling optics 116 includes a first waveplate 118a formed as a quarter waveplate and a second waveplate 118b formed as a three-eighths waveplate (e.g., based on selected wavelengths in the illumination 110). Such a configuration may be suitable for generating inspection system 100 with arbitrary polarization states by independently controlling the rotations (e.g., rotational positions) of the first waveplate 118a and the second waveplate 118b.

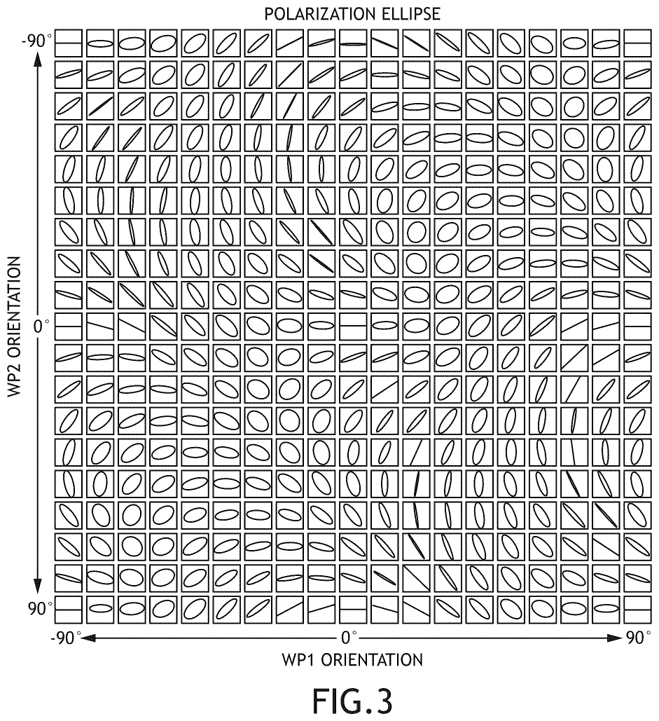

FIG. 3 depicts a matrix of polarization states (polarization ellipses) that may be achieved using different rotations of a waveplates 118 in the polarization controlling optics 116, in accordance with one or more embodiments of the present disclosure. In particular, FIG. 3 depicts polarization states that may be achieved using a first waveplate 118a formed as a quarter waveplate and a second waveplate 118b formed as a three-eighths waveplate in the configuration shown in FIG. 1C.

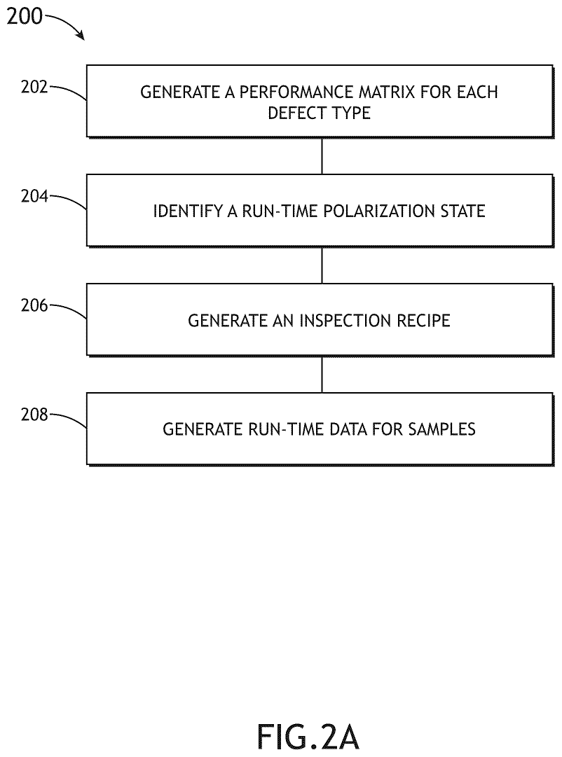

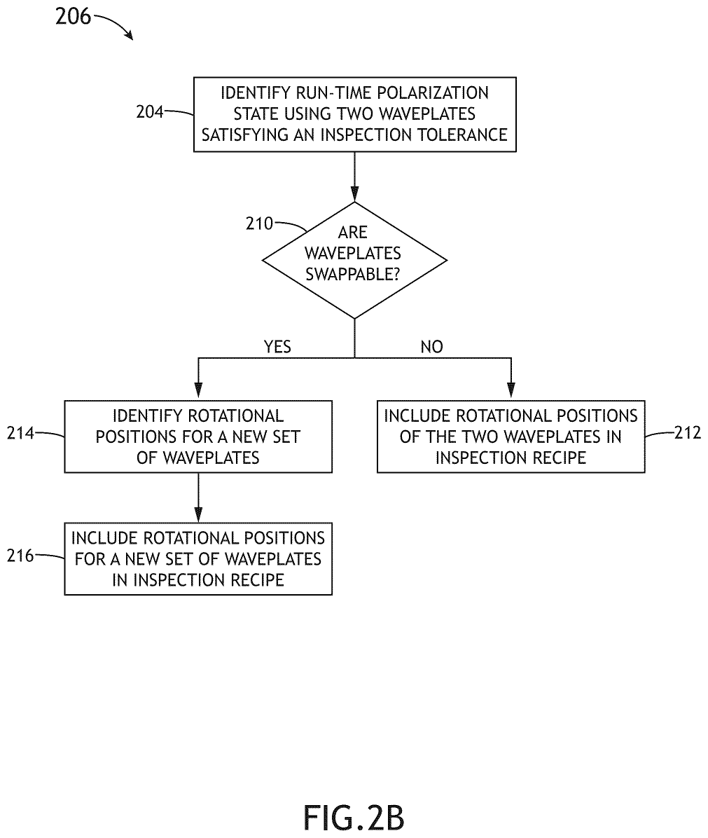

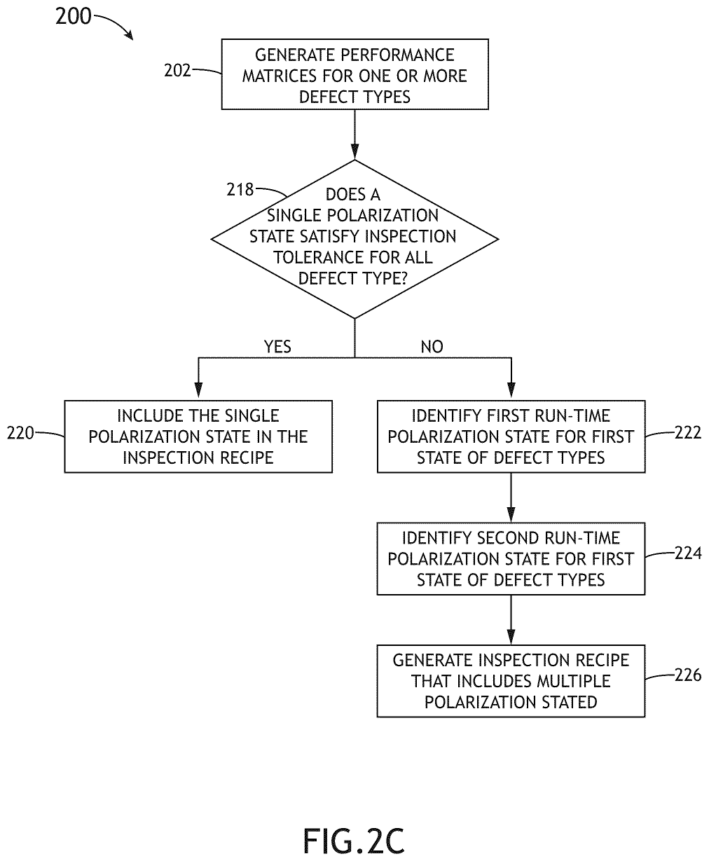

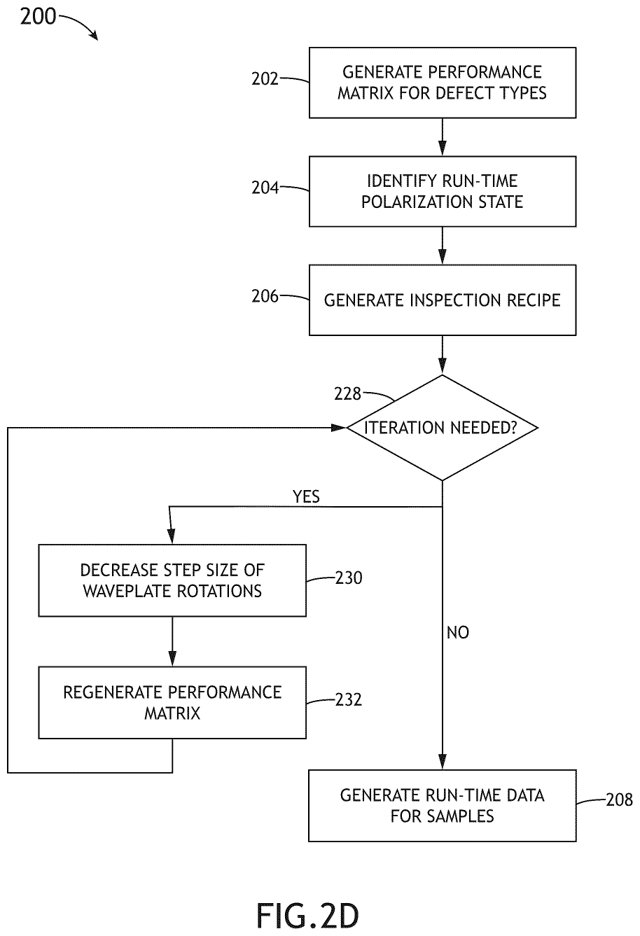

Referring now to FIGS. 2A-2D, FIGS. 2A-2D are flow diagrams illustrating methods for polarization selection and utilization in defect inspection.

FIG. 2A is a flow diagram illustrating steps performed in an inspection method 200, in accordance with one or more embodiments of the present disclosure. The embodiments and enabling technologies described previously herein in the context of the inspection system 100 should be interpreted to extend to the method 200. It is further noted, however, that the method 200 is not limited to the architecture of the inspection system 100.

The method 200 may include a step 202 of generating a performance matrix for each of one or more defect types. The performance matrix may include inspection data generated with a plurality of polarization states of illumination 110 associated with rotational positions of the waveplates 118 in the polarization controlling optics 116.

In some cases, the polarization controlling optics 116 may include a configuration as shown in FIG. 1C, with a first waveplate 118a and a second waveplate 118b positioned between the polarizing beamsplitter 120 and the sample 102. The performance matrix may incorporate inspection data for different waveplate 118 orientations from −90 degrees to 90 degrees with 10-degree steps. Any type of inspection data may be incorporated such as, but not limited to, signal-to-noise ratio (SNR), through-focus peak signal, or pattern feature edge ringing.

The step 202 of generating a performance matrix may be implemented using the inspection system 100 by configuring the polarization controlling optics 116 to systematically vary the rotational positions of the waveplates 118 while capturing inspection data with the detector 114, where the waveplates 118 may be manually rotated or controlled via the controller 122. In some cases, the processors 124 may execute program instructions stored in the memory 126 to control the rotational positions of the first waveplate 118a and second waveplate 118b through a range of orientations, such as from −90 degrees to 90 degrees in predetermined increments. The controller 122 may then process the detector data to extract inspection metrics for each defect type of interest, systematically building the performance matrix by associating each polarization state with its corresponding inspection performance data.

The method 200 may include a step 204 of identifying a run-time polarization state from the plurality of polarization states, wherein the run-time polarization state satisfies an inspection tolerance for the one or more defect types. The inspection tolerance may define minimum acceptable performance criteria that the polarization state must meet for effective defect detection, such as achieving a specified signal-to-noise ratio threshold, maintaining defect signal strength above a predetermined level, or ensuring detection sensitivity within acceptable limits.

The step 204 of identifying a run-time polarization state may be characterized as selecting an optimal polarization state that meets acceptable performance criteria for defect detection. This optimization process may involve evaluating multiple polarization states against predefined inspection tolerances and selecting the state that best satisfies these criteria across one or more defect types. The selected polarization state may not necessarily be the absolute best or perfect solution, but rather a configuration that provides a balance of performance characteristics suitable for the specific inspection requirements. In this context, optimization refers to finding a practical and effective solution that enhances overall defect detection capabilities within the constraints of the inspection system and the particular defect types of interest.

In some cases, identifying the run-time polarization state may be based on a dimensionality reduction operation. The dimensionality reduction operation may comprise any technique suitable for reducing the dimensionality of the performance matrix data. In some cases, the dimensionality reduction operation may comprise principal component analysis (PCA).

The PCA technique may operate by transforming the original performance matrix data into a new coordinate system where the axes (principal components) are ordered by the amount of information they capture in the data. Each principal component may be associated with an eigenvalue that quantifies the amount of information explained by that component. The eigenvalues may thus serve as indicators of the relative importance of each principal component, with larger eigenvalues corresponding to components that capture more significant trends in the data.

The utilization of PCA for polarization state selection may involve projecting the performance matrices for all defect types onto the principal component space. The first principal component may then be examined to determine which polarization states (corresponding to specific waveplate orientations) provide the highest values in this component. These polarization states may represent configurations that offer enhanced performance across multiple defect types simultaneously.

In some cases, the PCA analysis may enable the selection of a single optimized polarization state that satisfies inspection tolerances for multiple defect types of interest. The polarization state corresponding to the maximum value in the first principal component distribution may be selected as the optimal configuration. This approach may provide a systematic method for balancing detection performance across different defect types, rather than optimizing for individual defect types separately.

The second and subsequent principal components may capture additional, but less significant, variations in the performance data. While these components may provide insights into specific defect type behaviors, the first principal component may be most relevant for identifying polarization states that provide comprehensive coverage for all defect types of interest.

Further, as will be described in greater detail with respect to FIG. 20, it may be the case that a single polarization state may not satisfy an inspection tolerance for all defect types of interest. In such cases, step 204 may break a set of defect types of interest into multiple groups and select a polarization state for each group.

In some embodiments, the step 204 of identifying the run-time polarization state may incorporate penalty terms to account for additional performance considerations beyond the primary inspection metrics. The penalty terms may be added to the optimization process to discourage polarization states that may cause undesirable side effects such as pattern feature edge overshoot or undershoot, reduced photon throughput, or increased modeling noise. For example, when the optimization metric is based on peak through-focus signal-to-noise ratio, penalty terms may be applied to penalize configurations that result in excessive edge ringing artifacts or significant reduction in light transmission efficiency through the polarization controlling optics 116. The inclusion of penalty terms may help ensure that the selected run-time polarization state not only provides enhanced defect detection sensitivity but also maintains acceptable performance in other aspects of the inspection process, such as maintaining adequate signal levels and minimizing pattern distortion artifacts that could interfere with accurate defect identification.

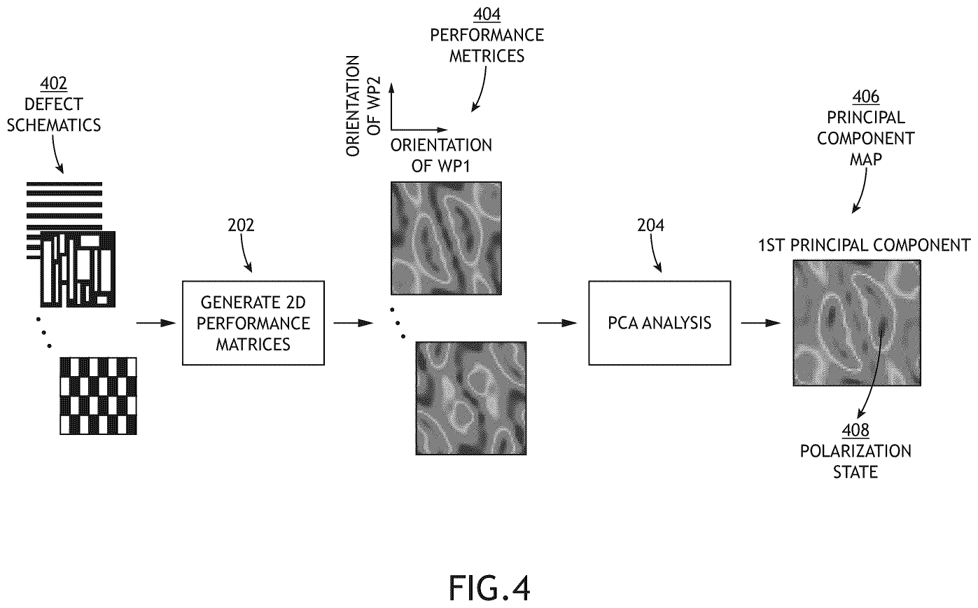

FIG. 4 illustrates a schematic flowchart for optimizing polarization settings in an inspection system using PCA, in accordance with one or more embodiments of the present disclosure. The flowchart begins with selecting a set of defect types of interest, which are shown here as defect schematics 402. Performance matrices 404 may then be generated (e.g., using step 202 of the method 200). For example, FIG. 4 shows the performance matrices visually as two-dimensional images, where intensity corresponds to performance associated with a selected metric.

The performance matrices 404 may then be analyzed (e.g., in step 204 of the method 200) to identify polarization configurations that satisfy inspection tolerances for the selected defect types. For example, a PCA analysis may provide a principal component map 406, which represents the first principal component of the analyzed data. In this case, a polarization stage suitable for inspection may be selected based on the principal component map 406 (e.g., as a point at a maximum or minimum of the principal component map 406). For example, FIG. 4 shows a location of a selected polarization state 408 (e.g., polarization ellipse) within the principal component map 406.

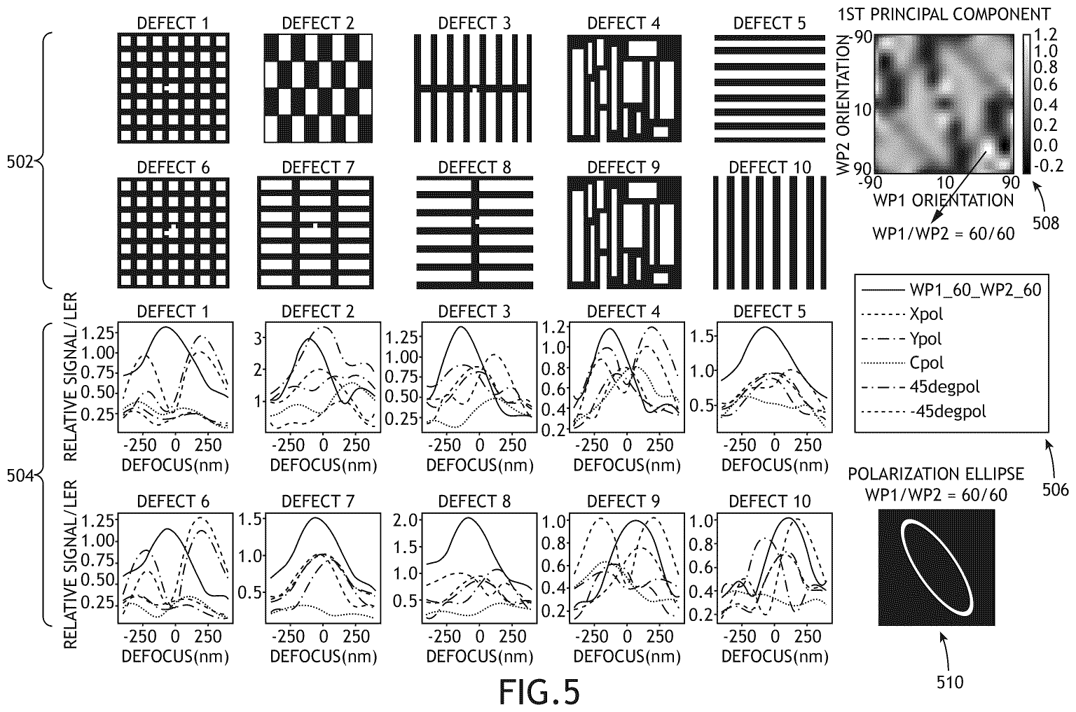

FIGS. 5-7 illustrate additional example implementations of the method 200, in accordance with one or more embodiments of the present disclosure.

FIG. 5 depicts a composite diagram showing defect analysis and polarization optimization results, in accordance with one or more embodiments of the present disclosure. The figure includes defect schematics 502 showing various defect types, with corresponding inspection data 504 displayed below each defect schematic 502 showing relative SNR measurements across different defocus values. The legend 506 indicates the different polarization settings and measurement conditions associated with the data in the inspection data 504. In particular, FIG. 5 illustrates defects associated with multi-layer (ML) protrusion and intrusion in dense contact arrays, defects in line-end to line-end regions, defects in complex regions, and defects in line/space regions.

In FIG. 5, the metric used for optimization is the peak through focus SNR, where pattern feature edge overshoot/undershoot, and photon throughput are added as penalty terms. The SNR is defined as the ratio between defect signal and line-edge roughness (LER) noise of the contact array region, where the defect signal is calculated as the maximum pixel-wise intensity in a difference image between defective and defect-free images. The LER noise is defined as the pixel-wise RMS in the difference image between LER-free and with LER images. Further, FIG. 5 depicts simulations associated with a numerical aperture (NA) of 0.9 and flat-top circular illumination 110 with coherence parameter σ=0.6. The peak SNR of X-pol light is used to normalize SNR values from all calculated polarization states for each defect type.

FIG. 5 further includes a principal component plot 508 showing the first principal component analysis. The polarization ellipse 510 depicts the polarization state selected in this example, which corresponds to rotations of 60 and 60 degrees for the two waveplates 118 (e.g., the first waveplate 118a and the second waveplate 118b in FIG. 1C).

Tables 1 and 2 further provide a summary of the through-focus inspection data 504 from FIG. 5.

TABLE 1
Through-focus inspection data

| | WP1/WP2 = 60/60 | | X-Pol | | Y-Pol | |
|---|---|---|---|---|---|---|
| | Peak | | Peak | | Peak | |
| Defect | Relative | Best Focus | Relative | Best Focus | Relative | Best Focus |
| Types | SNR | (nm) | SNR | (nm) | SNR | (nm) |
| Defect 1 | 1.30 | −70 | 1.00 | 190 | 1.20 | 200 |
| Defect 2 | 2.94 | −110 | 1.00 | 140 | 1.81 | 250 |
| Defect 3 | 1.34 | −140 | 1.00 | 110 | 0.88 | −130 |
| Defect 4 | 1.18 | −130 | 1.00 | 160 | 1.19 | 190 |
| Defect 5 | 1.61 | −70 | 1.00 | 130 | 0.87 | −20 |
| Defect 6 | 0.90 | −60 | 1.00 | 190 | 0.87 | 200 |
| Defect 7 | 1.49 | −60 | 1.00 | −30 | 0.93 | 60 |
| Defect 8 | 2.04 | −80 | 1.00 | −170 | 1.07 | 130 |
| Defect 9 | 0.98 | 70 | 1.00 | 210 | 0.60 | −100 |
| Defect 10 | 1.01 | 110 | 1.00 | 180 | 0.84 | −60 |

| | Maximum Best | | Maximum Best | | Maximum Best |
|---|---|---|---|---|---|
| Average | Focus | Average | Focus | Average | Focus |
| SNR | Difference | SNR | Difference | SNR | Difference |
| 1.48 | 250 | 1.00 | 380 | 1.03 | 380 |

TABLE 2
Additional through-focus inspection data

| | Circular-Pol | | 45deg-pol | | −45deg-pol | |
|---|---|---|---|---|---|---|
| | Peak | | Peak | | Peak | |
| Defect | Relative | Best Focus | Relative | Best Focus | Relative | Best Focus |
| Types | SNR | (nm) | SNR | (nm) | SNR | (nm) |
| Defect 1 | 0.27 | −320 | 0.32 | −290 | 0.39 | −290 |
| Defect 2 | 1.58 | 220 | 3.31 | 0 | 1.97 | −20 |
| Defect 3 | 0.47 | 130 | 0.80 | −10 | 0.85 | −20 |
| Defect 4 | 0.81 | 70 | 0.74 | −70 | 0.79 | −20 |
| Defect 5 | 0.61 | −210 | 0.95 | 10 | 0.95 | −20 |
| Defect 6 | 0.28 | 110 | 0.29 | −290 | 0.29 | −310 |
| Defect 7 | 0.32 | −160 | 0.99 | 10 | 1.00 | 0 |
| Defect 8 | 0.45 | 160 | 0.87 | 20 | 0.94 | −10 |
| Defect 9 | 0.62 | −150 | 0.53 | −180 | 0.73 | 110 |
| Defect 10 | 0.39 | −290 | 0.72 | 100 | 0.70 | 90 |

| | Maximum Best | | Maximum Best | | Maximum Best |
|---|---|---|---|---|---|
| Average | Focus | Average | Focus | Average | Focus |
| SNR | Difference | SNR | Difference | SNR | Difference |
| 0.58 | 540 | 0.95 | 390 | 0.86 | 420 |

As shown in Tables 1 and 2, the peak SNR value from X-polarized light is used to normalize the SNR values of all calculated polarization states for each defect type. With the optimized polarization state, the peak SNR demonstrates a significant increase for most of the tested defects, with the averaged SNR performance across all defect types showing approximately 50% enhancement compared to conventional polarization configurations. This substantial improvement demonstrates the effectiveness of this optimization methodology in enhancing detection sensitivity. Beyond SNR improvement, the best focus variation (the range of focus values that produce peak SNR) from the optimized polarization state is also reduced. Specifically, the best focus variation from optimized polarization remains within 250 nm, while the variation from X-polarized light extends to approximately 380 nm. This reduced focus variation ensures that most defects can be captured by the inspection system near their peak SNR region, further enhancing overall detection sensitivity.

The penalty terms added during the optimization process also improve system performance by reducing noise. Compared with X- or Y-polarized light generated from conventional polarization components (such as non-polarizing beam splitters or linear analyzers), the photon light efficiency of the optimized polarization setting (here, 60 degrees for both waveplates 118) through the polarizing beamsplitter 120 is increased by approximately 13% compared with a 25% light efficiency when using a 50/50 non-polarizing beam splitter. Such a configuration thus demonstrably reduces photon shot noise and increases sensitivity.

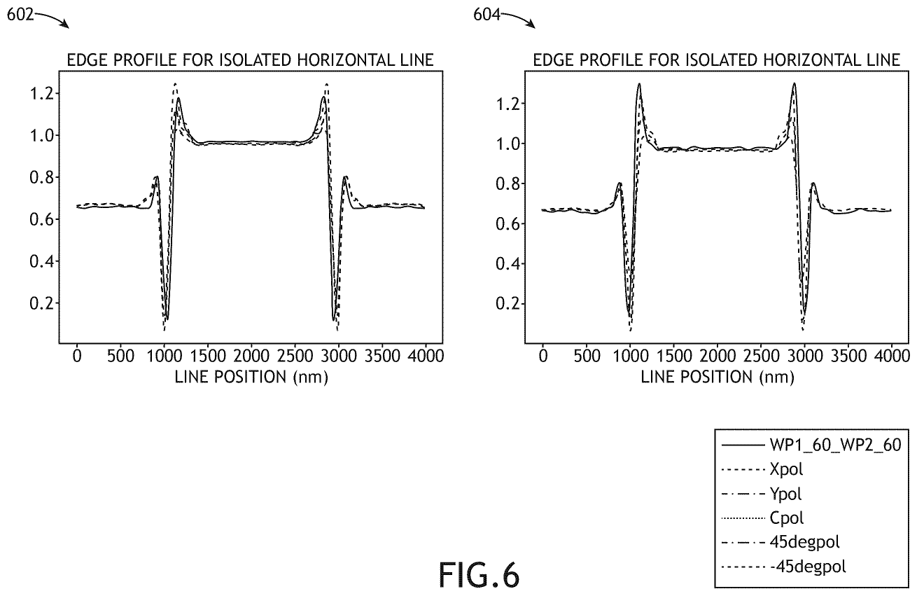

Additionally, the selected polarization state may maintain inspection tolerances associated with edge profile performance. FIG. 6 depicts edge profile plots for isolated horizontal and vertical patterns, in accordance with one or more embodiments of the present disclosure. In particular, FIG. 6 depicts a first plot 602 showing the edge profile for an isolated horizontal line and a second plot 604 showing the edge profile for an isolated vertical line. The edge profiles using the optimized polarization states may have similar overshoot values compared to conventional polarization states.

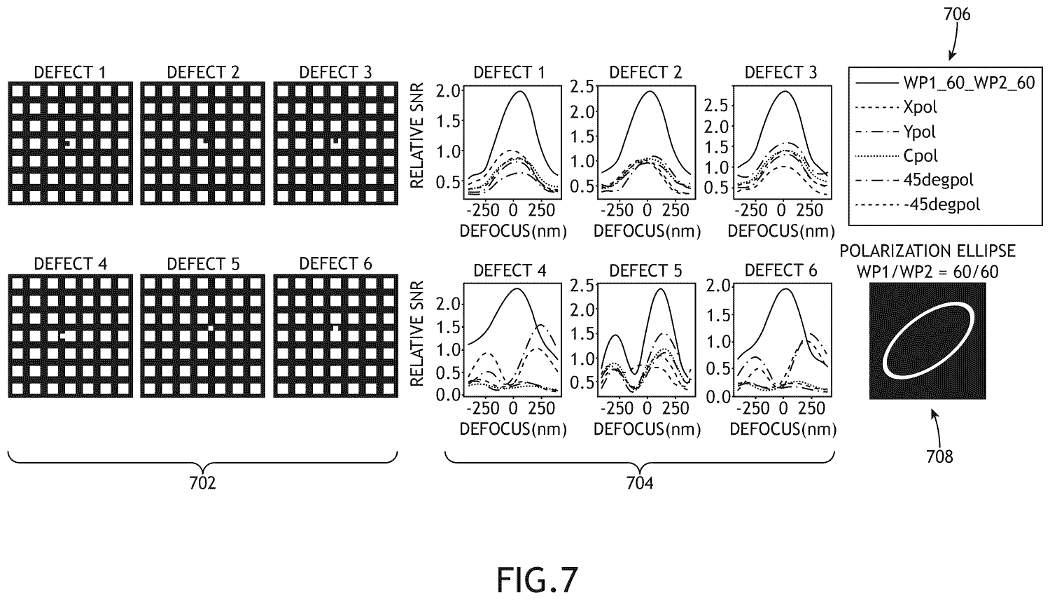

FIG. 7 depicts an additional example implementation of polarization selection, in accordance with one or more embodiments of the present disclosure. Similar to FIG. 5, FIG. 7 includes defect schematics 702 associated with defect types of interest, here shown as various ML protrusion and intrusion defects in dense contact array regions, along with associated inspection data 704. The legend 706 indicates the different polarization settings and measurement conditions associated with the data in the inspection data 504. In this example, the selected polarization state is shown by the polarization ellipse 708, which corresponds to orientations of the waveplates 118 of −60 and −70 degrees.

In FIG. 7, the SNR is defined as the ratio between defect signal and line-edge roughness (LER) noise of the contact array region. The defect signal is calculated as the maximum pixel-wise intensity in the difference image between defective and defect-free images. The LER noise is defined as the pixel-wise RMS (root mean square) in the difference image between LER-free and with LER images. The peak SNR of X-polarized light is used to normalize the SNR values from all calculated polarization states for each defect type. With the optimized polarization state (solid lines), the peak SNR of all 6 defects is boosted by more than 50% compared with conventional polarization settings (dashed lines), with the SNR enhancement ratio for defect2 exceeding 100%.

Referring again to FIG. 2A, additional steps of the method 200 are described.

The method 200 may include a step 206 of generating an inspection recipe to inspect one or more samples 102 with the illumination 110 having the run-time polarization state.

In some cases, the inspection recipe may include a configuration of the polarization controlling optics 116. The configuration may be designed to provide the polarization state selected in step 204.

The polarization state may be generated using any optical components. In some cases, the polarization controlling optics 116 may include the same waveplates 118 used when generating the performance matrices in step 202. In other cases, the waveplates 118 in the polarization controlling optics 116 used during runtime may be different than those used for polarization selection. For example, it may be the case that different inspection systems 100 are used for polarization selection (e.g., steps 202 and 204) and run-time (e.g., step 208 below).

FIG. 1D illustrates a block diagram of an inspection system with multiple configurations of polarization controlling optics 116, in accordance with one or more embodiments of the present disclosure. The figure shows three panels depicting different arrangements of the polarization controlling optics 116, all of which are configured to produce the polarization state shown in FIG. 5. For example, the forward and backward Jones matrices are shown in FIG. 5, which are the same for all three configurations.

The panel 144 shows a first configuration that is the same as FIG. 1C with a first waveplate 118a formed as a λ/4 waveplate oriented at 60 degrees and a second waveplate 118b formed as a 3λ/8 waveplate also oriented at 60 degrees.

The panel 146 depicts a second configuration with a single waveplate 118c, which is formed as a 3λ/8 waveplate oriented at −30 degrees. In this case, it may be possible to obtain the desired polarization state using a single waveplate 118 (waveplate 118c), which may beneficially reduce reflections and improve photon efficiency as well as alignment requirements.

The panel 148 illustrates a third configuration with three waveplates: a waveplate 118f, which is a λ/4 waveplate oriented at 80 degrees; a waveplate 118e, which is a λ/4 waveplate oriented at 51 degrees; and a waveplate 118d, which is a λ/4 waveplate oriented at 80 degrees. This configuration illustrates how a desired polarization state may be generated using only quarter waveplates, which may be readily available for many wavelengths.

It is to be understood that the three configurations in FIG. 1D are provided solely for illustrative purposes and should not be interpreted as limiting the scope of the present disclosure. Rather, a desired polarization state may be implemented in run-time using any optical components (e.g., any number or combination of waveplates of any thicknesses).

FIG. 2B illustrates a flowchart detailing a portion of a method for implementing polarization settings in an inspection system, in accordance with one or more embodiments of the present disclosure. In particular, FIG. 2B depicts the substeps of step 206 from FIG. 2A.

The method 200 may include a step 210 of determining whether the waveplates 118 are swappable. As used herein, the term swappable is used to indicate that optical components used to implement a selected polarization state are different than those used to select the polarization state. In some cases, the term swappable indicates that the physical waveplates 118 in a particular polarization controlling optics 116 are interchangeable (e.g., mounted on rotational or linear actuators). In some cases, the term swappable indicates that a different configuration of polarization controlling optics 116 in different versions of the inspection system 100 may be used.

If the waveplates 118 are swappable (Yes path), the method 200 may include a step 214 of identifying rotational positions for a new set of waveplates 118. Further, this step may include determining the rotational positions for the new set of waveplates 118 that produce the selected polarization state, which may be implemented using any technique including, but not limited to, Jones matrix techniques (e.g., as formulated in Equations (1)-(6)). Following step 214, the method 200 may include a step 216 of including the rotational positions for the new set of waveplates 118 in the inspection recipe.

If the waveplates 118 are not swappable (No path), the method 200 may include a step 212 of including the rotational positions of the two waveplates 118 in the inspection recipe.

The method 200 may include a step 208 of generating run-time data for the one or more samples 102 based on the inspection recipe with the inspection system 100. For example, the step 208 may correspond to implementation of the inspection recipe to generate inspection data in a high-volume manufacturing environment.

In some cases, the step 208 of generating run-time data may involve performing inspections using the optimized polarization settings determined in the previous steps. The inspection system 100 may be configured according to the inspection recipe generated in step 206, which may include specific rotational positions of the waveplates 118 in the polarization controlling optics 116 to achieve the run-time polarization state identified in step 204.

In some cases, the controller 122 may process the data from the detector 114 to generate run-time inspection measurements. These measurements may include metrics such as signal-to-noise ratio, defect signal strength, or other parameters relevant to defect detection and characterization.

FIG. 2C illustrates a flowchart of a method 200 for determining and implementing polarization states in an inspection system, in accordance with one or more embodiments of the present disclosure. In particular, the method 200 depicted in FIG. 2C addresses situations where a single polarization state may not be suitable for all defects of interest. In such cases, different polarization states may be determined for different groups of defects.

The method 200 may include a step 202 of generating performance matrices for one or more defect types. From the step 202, the method 200 may include a step 218 of determining whether a single polarization state satisfies inspection tolerance for all defect types.

If a single polarization state satisfies the inspection tolerance (Yes path), the method 200 may include a step 220 of including the single polarization state in the inspection recipe. For example, this may be the case when a single polarization state is sufficient for all defect types of interest.

If a single polarization state does not satisfy the inspection tolerance (No path), the method 200 may include a step 222 of identifying a first run-time polarization state for a first set of defect types. The method 200 may then include a step 224 of identifying a second run-time polarization state for a second set of defect types.

In some cases, the steps 222 and 224 may be repeated any number of times for any number of sets of defect types. For example, the controller 122 may identify additional run-time polarization states for additional sets of defect types beyond the first and second sets.

Following the step 224, the method 200 may include a step 226 of generating an inspection recipe that includes multiple polarization states. The inspection recipe may incorporate the identified polarization states for inspecting the different sets of defect types.

Referring generally to FIG. 2C, the defect types may be divided into different sets (e.g., groups) using any technique. For example, the grouping principle may be based on similarities (e.g., cross-correlation assessment). Additional grouping approaches may include, but are not limited to, clustering defects based on their physical characteristics (e.g., size, shape, or material composition), their location on the sample (e.g., edge regions versus central regions), their response to specific polarization states, or their impact on device functionality. As another example, defect types may be grouped according to their detection sensitivity requirements, with critical defects that require higher detection confidence placed in one group and less critical defects placed in another.

In some implementations, machine learning algorithms such as k-means clustering or hierarchical clustering may be employed to automatically identify natural groupings within the defect population based on multiple performance parameters simultaneously.

The implementation of multiple polarization states for different defect groups may impact the step 208 of generating run-time data. In some cases, the step 208 may require multiple inspection passes with the different selected polarization states to inspect for defects in the associated groups. For example, the inspection system 100 may perform a first inspection pass using the first run-time polarization state to detect defects in the first set of defect types, followed by a second inspection pass using the second run-time polarization state to detect defects in the second set of defect types. This process may be repeated for any additional polarization states and defect type sets identified in the method 200.

In some cases, the controller 122 may identify the run-time polarization states from the plurality of polarization states based on a dimensionality reduction operation. For example, the dimensionality reduction operation may include principal component analysis (PCA) as described previously herein. The PCA technique may be applied separately to each set of defect types to determine the optimal polarization state for that specific group.

FIG. 2D illustrates a flowchart of a method 200 for optimizing polarization settings in an inspection system, in accordance with one or more embodiments of the present disclosure. The method 200 depicted in FIG. 2D shows an iterative process for refining polarization settings described above with respect to steps 202 and 204.

In some cases, a multi-iteration procedure as shown in FIG. 2D may improve the throughput of identifying a polarization state in the step 204. The computational speed when implementing the dimensionality reduction technique may be impacted by the number of rotational orientations of the waveplates 118. Breaking the process into multiple iterations may improve the overall speed by initially using a coarser sampling of waveplate 118 orientations and progressively refining the search space.

The method 200 begins with a step 202 of generating a performance matrix for defect types. From the step 202, the method 200 proceeds to a step 204 of identifying a run-time polarization state. Following the step 204, the method 200 may advance to the step 206 of generating an inspection recipe.

From the step 206, the method 200 moves to a step 228 of determining whether iteration is needed. The step 228 may involve evaluating whether the current polarization state meets the desired accuracy or performance criteria.

If iteration is needed (Yes path), the method 200 includes a step 230 of iteratively decreasing the step size of waveplate 118 rotations (e.g., implementing increasingly smaller step sizes). The method 200 then may then include a step 232 of regenerating the performance matrix based on the decreased (e.g., smaller) step size, focusing on the region around the previously identified optimal configuration.

At the initial iteration, the step size of the rotational positions of the waveplates 118 may be set sparsely. For example, the initial iteration may use a coarse sampling of waveplate 118 orientations, such as 30-degree increments. After each optimization round is performed, another iteration may be added by narrowing down the range and step size of each variable around the best configuration, such as reducing the step size to 10-degree increments centered around the previously identified optimal orientation. This process may continue until the step size is small enough (e.g., 1-degree increments) and the target accuracy of the optimization flow is reached. It is to be understood that these iteration examples are merely illustrative and not limiting.

Once no further iterations are needed, the method 200 may proceed to the step 208 of generating run-time data for samples 102 as described in FIG. 2A.

In some cases, the controller 122 may perform the steps of generating the performance matrix and identifying the run-time polarization state iteratively. The processors 124 may execute program instructions stored in the memory 126 to implement the iterative process, progressively refining the polarization settings by adjusting waveplate 118 rotation step sizes and regenerating performance matrices until the desired optimization is achieved.

The multi-iteration procedure illustrated in FIG. 2D may provide several advantages for selecting the polarization state. For example, this approach may balance a trade-off between computational efficiency and accuracy. Initially, the algorithm may explore a wide range of waveplate orientations using large step sizes, which allows for a rapid assessment of the overall performance landscape. This broad sweep helps identify promising regions in the polarization state space without expending excessive computational resources on fine-grained analysis of potentially suboptimal areas.

As the iterations progress, the step size for waveplate rotations is systematically reduced, focusing the search on the most promising regions identified in previous iterations. This refinement process may provide a detailed exploration of high-performing polarization states, potentially uncovering optimal configurations that may be missed with a fixed-resolution approach. The adaptive nature of this technique also allows for efficient allocation of computational resources, dedicating more intensive calculations to areas of the polarization state space that are most likely to yield improvements in defect detection performance.

Further, this iterative approach provides flexibility in balancing computation time against optimization precision. In time-sensitive scenarios, the process can be terminated after fewer iterations to quickly obtain a good, if not optimal, polarization state. Conversely, when maximum performance is critical, additional iterations can be performed to fine-tune the polarization settings to a high degree of precision.

The multi-iteration procedure also aligns well with the dimensionality reduction techniques used in the optimization process, such as PCA. As the search space is refined, the dimensionality reduction technique can be reapplied to the more focused dataset, potentially revealing more nuanced relationships between polarization states and defect detection performance that may not be apparent in the initial, coarser analysis.

Any of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific example is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A recipe generation system comprising:
a controller including one or more processors configured to execute program instructions causing the one or more processors to:
generate a performance matrix for each of one or more defect types, wherein the performance matrix includes inspection data generated with a plurality of polarization states of illumination light associated with rotational positions of at least two waveplates in a polarization controlling optics of an inspection system, wherein the polarization controlling optics comprises a polarizing beam splitter and the at least two waveplates positioned between the polarizing beam splitter and a sample, wherein the inspection system generates the inspection data by propagating the illumination light through the polarization controlling optics to the sample and capturing light from the sample by a detector through the polarization controlling optics;
identify a run-time polarization state from the plurality of polarization states, wherein the run-time polarization state satisfies an inspection tolerance for the one or more defect types; and
generate an inspection recipe to inspect one or more samples with the illumination light having the run-time polarization state.

2. The recipe generation system of claim 1, wherein the inspection recipe defines the rotational positions of the at least two waveplates of the polarization controlling optics.

3. The recipe generation system of claim 1, wherein the at least two waveplates of the polarization controlling optics comprise a first set of waveplates, wherein the first set of waveplates is swappable with at least a second set of waveplates, wherein the second set of waveplates includes one or more second waveplates, wherein the program instructions further cause the one or more processors to identify rotational positions of the one or more second waveplates providing the run-time polarization state, wherein the inspection recipe defines the rotational positions of the one or more second waveplates providing the run-time polarization state.

4. The recipe generation system of claim 3, wherein the one or more second waveplates comprise a single second waveplate.

5. The recipe generation system of claim 3, wherein the one or more second waveplates comprise one or more quarter waveplates.

6. The recipe generation system of claim 1, wherein the one or more defect types comprises two or more defect types.

7. The recipe generation system of claim 6, wherein identifying the run-time polarization state from the plurality of polarization states comprises:
identifying the run-time polarization state from the plurality of polarization states based on a dimensionality reduction operation.

8. The recipe generation system of claim 7, wherein the dimensionality reduction operation comprises principal component analysis.

9. The recipe generation system of claim 6, wherein identifying the run-time polarization state from the plurality of polarization states comprises:
identifying a first run-time polarization state from the plurality of polarization states, wherein the first run-time polarization state satisfies the inspection tolerance for a first set of the two or more defect types; and
identifying a second run-time polarization state from the plurality of polarization states, wherein the second run-time polarization state satisfies the inspection tolerance for a second set of the two or more defect types.

10. The recipe generation system of claim 1, wherein generating the performance matrix for each of the one or more defect types and identifying the run-time polarization state from the plurality of polarization states are performed iteratively with increasingly smaller step sizes of variations of the rotational positions of the at least two waveplates.

11. The recipe generation system of claim 1, wherein the inspection tolerance is based on a metric incorporating at least one of signal to noise ratio, through-focus peak signal, or pattern feature edge ringing.

12. An inspection system comprising:
an inspection sub-system comprising:
an illumination source configured to generate illumination light;
a polarization controlling optics positioned in an optical path between the illumination source and a sample, the polarization controlling optics comprising a polarizing beam splitter and at least two waveplates positioned between the polarizing beam splitter and the sample, wherein the at least two waveplates are separately rotatable; and
a detector configured to collect light from the sample through the polarization controlling optics; and
a controller including one or more processors configured to execute program instructions causing the one or more processors to:
generate a performance matrix for each of one or more defect types, wherein the performance matrix includes inspection data generated with a plurality of polarization states of the illumination light associated with rotational positions of the at least two waveplates in the polarization controlling optics;
identify a run-time polarization state from the plurality of polarization states, wherein the run-time polarization state satisfies an inspection tolerance for the one or more defect types;
generate an inspection recipe to inspect one or more samples with the illumination light having the run-time polarization state, wherein the inspection sub-system is configured to inspect the one or more samples based on the inspection recipe; and
generate run-time inspection measurements for the one or more samples based on data from the inspection sub-system.

13. The inspection system of claim 12, wherein the inspection recipe defines the rotational positions of the at least two waveplates of the polarization controlling optics.

14. The inspection system of claim 12, wherein the at least two waveplates of the polarization controlling optics comprise a first set of waveplates, wherein the first set of waveplates is swappable with at least a second set of waveplates, wherein the second set of waveplates includes one or more second waveplates, wherein the program instructions further cause the one or more processors to identify rotational positions of the one or more second waveplates providing the run-time polarization state, wherein the inspection recipe defines the rotational positions of the one or more second waveplates providing the run-time polarization state.

15. The inspection system of claim 12, wherein the one or more defect types comprises two or more defect types.

16. The inspection system of claim 15, wherein identifying the run-time polarization state from the plurality of polarization states comprises:
identifying the run-time polarization state from the plurality of polarization states based on a dimensionality reduction operation.

17. The inspection system of claim 15, wherein identifying the run-time polarization state from the plurality of polarization states comprises:
identifying a first run-time polarization state from the plurality of polarization states, wherein the first run-time polarization state satisfies the inspection tolerance for a first set of the two or more defect types; and
identifying a second run-time polarization state from the plurality of polarization states, wherein the second run-time polarization state satisfies the inspection tolerance for a second set of the two or more defect types.

18. The inspection system of claim 12, wherein generating the performance matrix for each of the one or more defect types and identifying the run-time polarization state from the plurality of polarization states are performed iteratively with increasingly smaller step sizes of variations of the rotational positions of the at least two waveplates.

19. The inspection system of claim 12, wherein the sample comprises a photomask.

20. The inspection system of claim 12, wherein the illumination light comprises deep ultraviolet light.

21. An inspection method comprising:
generating a performance matrix for each of one or more defect types, wherein the performance matrix includes inspection data generated with a plurality of polarization states of illumination light associated with rotational positions of at least two waveplates in a polarization controlling optics of an inspection system, wherein the polarization controlling optics comprises a polarizing beam splitter and the at least two waveplates positioned between the polarizing beam splitter and a sample, wherein the inspection system generates the inspection data by propagating the illumination light through the polarization controlling optics to the sample and capturing light from the sample by a detector through the polarization controlling optics;
identifying a run-time polarization state from the plurality of polarization states, wherein the run-time polarization state satisfies an inspection tolerance for the one or more defect types;
generating an inspection recipe to inspect one or more samples with the illumination light having the run-time polarization state; and
generating run-time data for the one or more samples based on the inspection recipe with the inspection system.

22. The inspection method of claim 21, wherein generating the inspection recipe to inspect the one or more samples with the illumination light having the run-time polarization state comprises:
generating the inspection recipe to include the rotational positions of the at least two waveplates of the polarization controlling optics.

23. The inspection method of claim 21, wherein the at least two waveplates of the polarization controlling optics comprise a first set of waveplates, wherein the first set of waveplates is swappable with at least a second set of waveplates, wherein the second set of waveplates includes one or more second waveplates, wherein generating the inspection recipe to inspect the one or more samples with the illumination light having the run-time polarization state comprises identifying rotational positions of the one or more second waveplates providing the run-time polarization state.

24. The inspection method of claim 21, wherein identifying the run-time polarization state from the plurality of polarization states comprises:
identifying the run-time polarization state from the plurality of polarization states based on a dimensionality reduction operation.

25. The inspection method of claim 21, wherein the one or more defect types comprises two or more defect types, wherein identifying the run-time polarization state from the plurality of polarization states comprises:
identifying a first run-time polarization state from the plurality of polarization states, wherein the first run-time polarization state satisfies the inspection tolerance for a first set of the two or more defect types; and
identifying a second run-time polarization state from the plurality of polarization states, wherein the second run-time polarization state satisfies the inspection tolerance for a second set of the two or more defect types.

26. The inspection method of claim 21, wherein generating the performance matrix for each of the one or more defect types and identifying the run-time polarization state from the plurality of polarization states are performed iteratively with increasingly smaller step sizes of variations of the rotational positions of the at least two waveplates.
